(19) United States
(12) Patent Application Publication
(10) Pub. No.: US 2021/0056476 A1
(43) Pub. Date: Feb. 25, 2021

(54) METHOD AND SYSTEM FOR SECURE DATA SHARING

(71) Applicant: Oath Inc., New York, NY (US)

(72) Inventors: David K. Westbrook, Champaign, IL (US); Yugandhar Reddy Boyapally, Champaign, IL (US); Will C. Lauer, Champaign, IL (US); Lee Rhodes, Los Altos, CA (US)

(21) Appl. No.: 16/547,011

(22) Filed: Aug. 21, 2019

(51) Int. Cl. G06Q 10/06; G06F 16/906; G06F 16/901

(52) U.S. Cl. CPC G06Q 10/0635; G06Q 10/067; G06F 16/9014; G06F 16/906; G06Q 10/06375

(57) ABSTRACT

The present teaching relates to a method and system for securely sharing data between a group of data owners. A data owner generates mapping information in accordance with a model. The data owner generates a first data-sketch corresponding to proprietary data associated with the data owner. The mapping information and the first data-sketch are transmitted by the data owner to other data owners in the group of data owners. The data owner receives, from each of the other data owners, a second data-sketch corresponding to proprietary data associated with the other data owner, wherein the second data-sketch is generated based on the mapping information. The data owner processes the first data-sketch and the second data-sketches to generate combined data.

### BACKGROUND

### 1. Technical Field

The present teaching generally relates to data processing. More specifically, the present teaching relates to techniques of generating and sharing data in a secure manner.

### 2. Technical Background

In the age of the Internet, amount of data available becomes explosive. Great effort has been made to analyze the vast amount of data to make some sense out of it in order to improve the efficiency associated with data access. Real-time analytics are becoming increasingly prevalent in many businesses. For instance, Big-data analytics often needs to answer queries that capture the salient properties of large data streams. As such, data is often considered as a sole source of value for any company or organization that is modernized enough to have data systems.

As organizations continue to experience a data gold rush such as Internet-of-Things and Industrial-Internet-of-things industries, a persistent problem being faced by such organizations is a lack of a mechanism to combine data and derive new value without incurring some sort of risks. As a result, the potential value of combining data is often never realized because of the risks inherent in doing so. In some instances, data sharing deals between different organizations are implemented without having a proper risk mitigation in place, which results in unintended or negative consequences to arise.

Accordingly, there is a need for solutions to address the above stated problems. Specifically, there is a requirement for a system and method for sharing data in a manner that minimizes the risks inherent in data sharing, while simultaneously minimizing the tradeoff between the quality of data insights and risk mitigation.

### SUMMARY

The teachings disclosed herein relate to methods, systems, and programming for data processing. More specifically, the present teaching relates to techniques of generating and sharing data in a secure manner.

One aspect of the present disclosure provides for a method, implemented on a machine having at least one processor, storage, and a communication platform capable of connecting to a network for sharing data between a group of data owners. A data owner generates mapping information in accordance with a model. A first data-sketch corresponding to proprietary data associated with the data owner is generated by the data owner. The mapping information and the first data-sketch is transmitted by the data owner to other data owners in the group of data owners. The data owner receives, from each of the other data owners, a second data-sketch corresponding to proprietary data associated with the other data owner, wherein the second data-sketch is generated based on the mapping information. The data owner processes the first data-sketch and the second data-sketches to generate combined data.

By one aspect of the present disclosure, there is provided a system for system for securely sharing data between a group of data owners. The system includes a mapping information generator configured for generating mapping information associated with a data owner in accordance with a model. A data-sketch generator is configured for generating, a first data-sketch corresponding to proprietary data associated with the data owner. A transmitting unit transmits the mapping information and the first data-sketch to other data owners in the group of data owners. A receiving unit receives, from each of the other data owners, a second data-sketch corresponding to proprietary data associated with the other data owner, wherein the second data-sketch is generated based on the mapping information, and a data processing unit processes the first data-sketch and the second data-sketches to generate combined data.

Other concepts relate to software for implementing the present teaching. A software product, in accord with this concept, includes at least one machine-readable non-transitory medium and information carried by the medium. The information carried by the medium may be executable program code data, parameters in association with the executable program code, and/or information related to a user, a request, content, or other additional information.

In one example, there is provided, a machine-readable, non-transitory and tangible medium having data recorded thereon for sharing data between a group of data owners. A data owner generates mapping information in accordance with a model. A first data-sketch corresponding to proprietary data associated with the data owner is generated by the data owner. The mapping information and the first data-sketch is transmitted by the data owner to other data owners in the group of data owners. The data owner receives, from each of the other data owners, a second data-sketch corresponding to proprietary data associated with the other data owner, wherein the second data-sketch is generated based on the mapping information. The data owner processes the first data-sketch and the second data-sketches to generate combined data.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an operational configuration for data sharing in a network setting, according to an embodiment of the present teaching;

FIG. 2 depicts another operational configuration for data sharing in a network setting, according to an embodiment of the present teaching;

FIG. 3 depicts another operational configuration for data sharing in a network setting, according to an embodiment of the present teaching;

FIG. 4 depicts an exemplary high-level system diagram of a data owner, according to an embodiment of the present teaching;

FIG. 5 is a flowchart of an exemplary process performed by a data owner, according to an embodiment of the present teaching;

FIG. 6 depicts an exemplary high-level system diagram of a sequential theta sketch generator, according to an embodiment of the present teaching;

FIG. 7 is a flowchart of an exemplary process of a sequential theta sketch generator, according to an embodiment of the present teaching;

FIG. 8 depicts an exemplary high-level system diagram of a data analytics engine, according to an embodiment of the present teaching;

FIG. 9 is a flowchart of an exemplary process performed by a data analytics engine, according to an embodiment of the present teaching;

FIG. 10A depicts an exemplary timing diagram of a symmetric mode of data sharing, according to an embodiment of the present teaching;

FIG. 10B depicts an exemplary timing diagram of an asymmetric mode of data sharing, according to an embodiment of the present teaching;

FIG. 10 C depicts an exemplary timing diagram of a third party mode of data sharing, according to an embodiment of the present teaching;

FIG. 11 depicts an architecture of a mobile device which can be used to implement a specialized system incorporating the present teaching; and

FIG. 12 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein. Example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Aspects of the present disclosure provide for methods to produce quality data insights produced from various parties combining data, while protecting the interests of all parties involved by mitigating the risks inherent in traditional methods of sharing data with the intent of combining it. The premise of the proposed methods is that all measures of valuable data can be measured in terms of uniqueness. For example, in digital advertising, the value of a publisher's property is often derived from some form of unique monthly active users or the number of unique devices which have a given application (i.e., an ‘app’) installed thereon.

An advertiser may want to run advertisements with a given publisher. In order to do so, the advertiser may need to know if the users that buy their products frequently visit the publisher's website. To solve this with traditional methods, the publisher either must give all of their user data (i.e., which users saw advertisements) or the advertiser must give publishers data related to which user(s) purchased items. If the publisher shares their user-level data with the advertiser, then the publisher runs the risk of having the advertiser shop for a competing publisher property to advertise to the same users at a lower price. Such a situation is bad for publishers and users, as it puts publishers in a position where they need to focus on bringing users to their property as cheaply as possible as opposed to focusing on producing the most value for the user by either producing higher quality content or better features on their property.

On the other hand, without the insight of knowing how many potential customers are on the publisher's property, the advertiser risks burning their marketing budget and producing no net new customers or even knowing if their advertisements were effective. Such a situation is also not good for users. When users visit a website, they are often not aware of whether or not their browsing history is being shared with an advertiser even though such data sharing is described in most standard end user license agreements. When users buys a product, they are often not aware that the advertiser may share their respective purchase data with the publisher(s) in order to enable the advertising.

As such, in what follows, there is provided mechanisms of sharing data between users/entities in a manner that maximizes the quality of derived insights, while minimizes the potential for any single entity to learn something they did not know before about the proprietary data of any of the parties involved. Specifically, by some embodiments of the present disclosure, rather than sharing raw data (also referred to herein as proprietary data), a data sketch (corresponding to the proprietary data) is shared by entities. Since the size of a data sketch is most often significantly smaller than the size of the data (i.e., raw data) which produced it, the techniques of data sharing of the present disclosure also offer a fringe-benefit in that it is anticipated to be cost effective in terms of hardware resources required to process data.

According to an embodiment of the present disclosure, the techniques for combining and sharing data as described herein are based on the principles of deterministic sampling and value obfuscation. Deterministic sampling can significantly reduce the amount of data shared by all parties (i.e., entities) as well as produce a low relative error when measuring Jaccard similarity (a parameter used for measuring data quality). Moreover, deterministic sampling also reduces the value of data acquired by a malicious entity (i.e., a hacker or party to agreement acting outside of the confines of data sharing agreement).

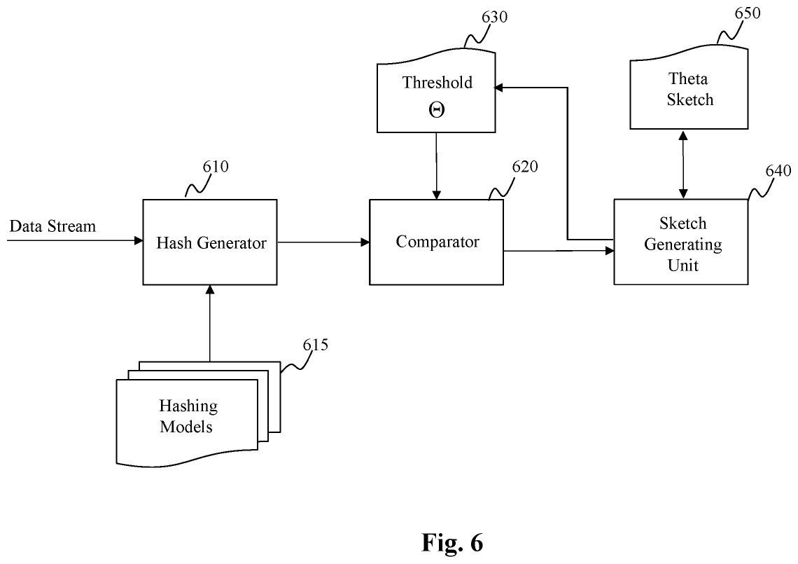

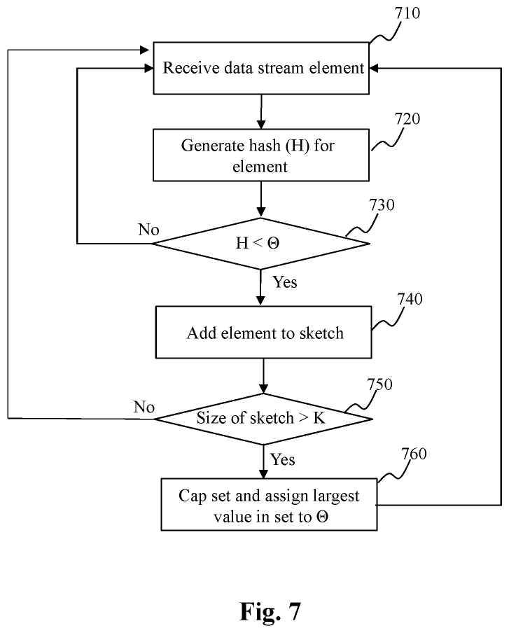

By one embodiment, value obfuscation is obtained by using hash functions in the generation of data sketches. Details regarding the generation of data sketches is described later with reference to FIGS. 6 and 7. It must be appreciated that value obfuscation reduces the value of data obtained by any given malicious actor (i.e., a hacker or a party to agreement acting outside of the confines of data sharing agreement). Moreover, in a situation where some third party is facilitating the data sharing arrangement, value obfuscation prevents the third party from learning anything meaningful about either party's proprietary data. Aspects of the present disclosure provide for techniques of combining and sharing data in a symmetric manner, an asymmetric manner, as well a process of combining and sharing data performed under the control of a third party vendor.

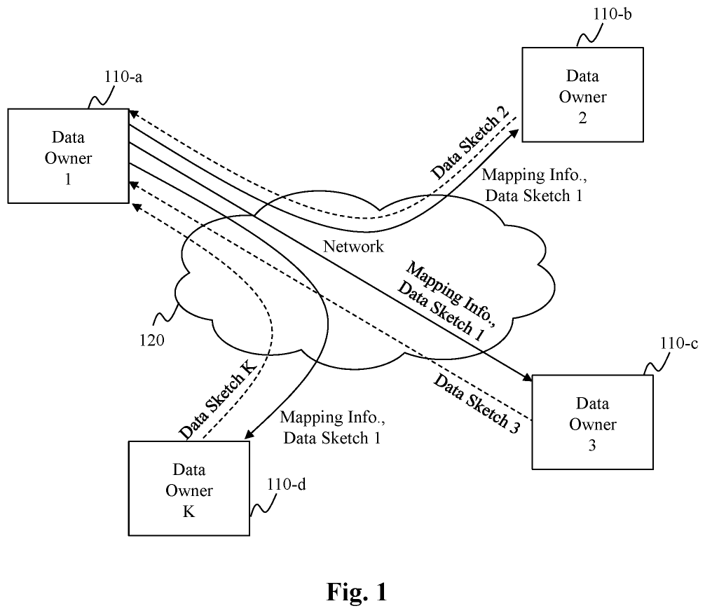

FIG. 1 depicts an operational configuration for data sharing in a network setting, according to an embodiment of the present teaching. Specifically, FIG. 1 depicts a symmetric configuration for data sharing between a group of entities. An entity is also referred to herein as a data owner. A data owner may include, but is not limited to, to an individual, an advertiser, a publisher, a business entity, a content collection agency such as Twitter, Facebook, or blogs, that gather different types of content, online or offline, such as news, papers, blogs, social media communications, magazines, whether textual, audio visual such as images or video content.

FIG. 1 depicts four data owners: data owner 1 110-a, data owner 2 110-b, data owner 3, 110-c, and data owner K, 110-d that communicate with one another via a network 120. The network 120 may be a single network or a combination of different networks. For example, a network may be a local area network (LAN), a wide area network (WAN), a public network, a private network, a proprietary network, a Public Telephone Switched Network (PSTN), the Internet, a wireless network, a cellular network, a Bluetooth network, a virtual network, or any combination thereof. The network 120 may also include various network access points, e.g., wired or wireless access points such as base stations or Internet exchange points (not shown) through which a data source may connect to the network 120 in order to transmit/receive information via the network.

In the symmetric mode of operation, each data owner is configured to share its data with other data owners. It must be appreciated that in contrast to sharing raw data, each data owner shares a data sketch (which captures salient properties of the raw/proprietary data) with other data owners. In operation, a particular data owner (e.g., data owner 110-a) generates mapping information and transmits the mapping information to all other data owners. The mapping information ensures that the data owners map users in a common ID space. The selection of the particular data owner that is configured to generate and transmit the mapping information may be based on several criterion such as selecting the data owner with the most amount of proprietary data, business agreements between the various data owners, etc.

The particular data owner (i.e., data owner 1 110-a in the example depicted in FIG. 1) further generates a data sketch (i.e., data sketch 1) and transmits the data sketch to all other data owners. By one embodiment, the generated data sketch is a Theta sketch. Details regarding the generation of the Theta sketch are described later with reference to FIG. 6.

Each of the other data owners i.e., data owner 2 110-b, data owner 3, 110-c, and data owner K, 110-d generates a data sketch corresponding to it's proprietary data based on the mapping information received from data owner 1 110-a and transmits the generated data sketch to all other data owners. In this manner, each data owner has a copy of data sketches of all other data owners. Note that in FIG. 1, the data sketches generated by data owner 2 110-b, data owner 3, 110-c, and data owner K, 110-d, respectively (i.e., data sketch 2, data sketch 3, and data sketch K) are shown to be transmitted only to data owner 110-a for sake of clarity. In this manner, each data owner may obtain data sketches of other data owners and perform data sketch operations (e.g., set operations, theta-operations, etc.) to generate combined data.

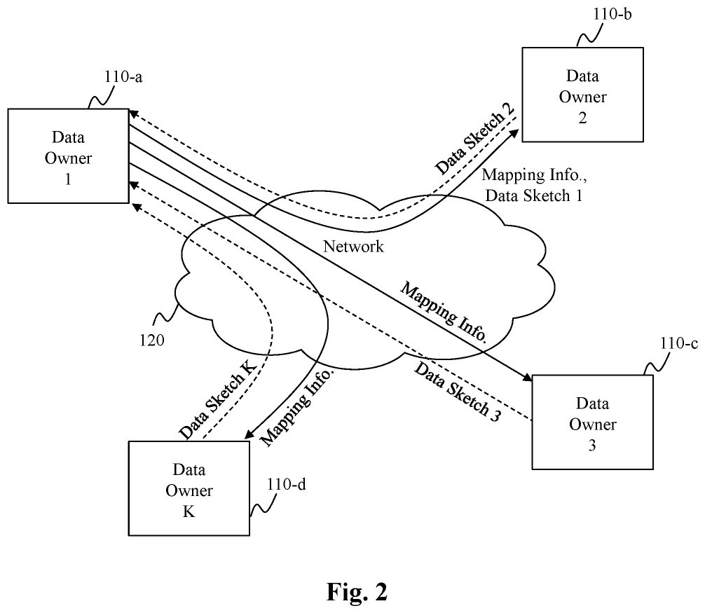

Turning to FIG. 2, there is depicted another operational configuration for data sharing in a network setting, according to an embodiment of the present teaching. Specifically, FIG. 2 depicts an asymmetric configuration for data sharing between a group of entities. In the asymmetric mode of operation, all data owners share data but not all data owners receive data in return. As shown in FIG. 2, the four data owners: data owner 1 110-a, data owner 2 110-b, data owner 3, 110-c, and data owner K, 110-d communicate with one another via a network 120.

Similar to FIG. 1, a particular data owner (e.g., data owner 110-a) generates mapping information and transmits the mapping information to all other data owners. The mapping information ensures that the data owners map users in a common ID space. However, in contrast to FIG. 1, in the asymmetric mode of operation as shown in FIG. 2, data owner 1 transmits its data sketch to a subset of other data owners. For instance, data owner 1 transmits its data sketch (i.e. data sketch 1) to only data owner 2 110-b and not to data owner 3 and data owner K.

The other data owners upon receiving the mapping information from the particular data owner (e.g., data owner 1), generate data sketches corresponding to their proprietary data based on the mapping information received from data owner 1 and transmit the generated data sketches to a subset of other data owners. In this manner, in the asymmetric mode of operation, all data owners share data but not all data owners receive data in return. Further, each data owner may obtain a subset of data sketches of other data owners and perform data sketch operations (e.g., set operations, theta-operations, etc.) to generate combined data. It must be appreciated that a set of business agreements or rules between the various data owners may be implemented to determine which data owner(s) receive/transmit data sketches from/to other data owners. For example, a data owner with the most amount of proprietary data may be configured to receive data sketches from all other data owners but may transmit its own data sketch to only a small subset of other data owners.

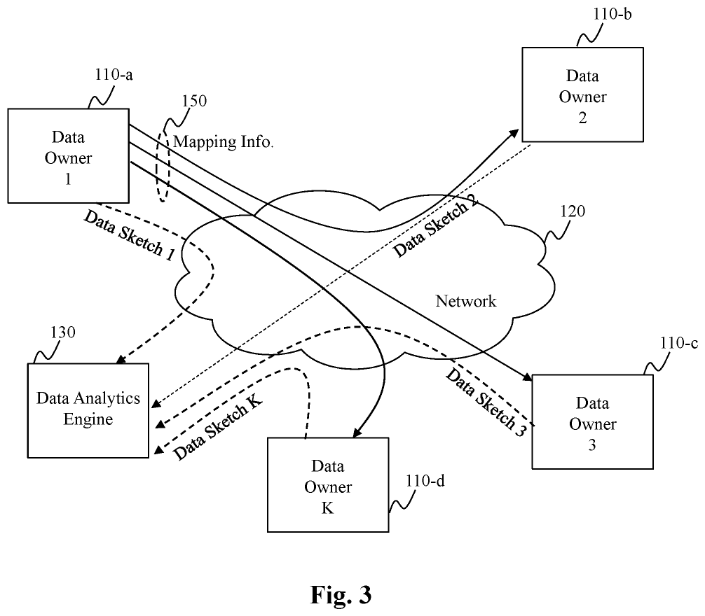

FIG. 3 depicts another operational configuration for data sharing in a network setting, according to an embodiment of the present teaching. Specifically, FIG. 3 depicts data sharing between a group of entities performed under the control of a third party vendor (i.e., a data analytics engine). As shown in FIG. 3, a group of data owners i.e., data owner 1 110-a, data owner 2 110-b, data owner 3, 110-c, and data owner K, 110-d communicate with a data analytics engine 130 via a network 120. The mode of operation as depicted in FIG. 3 is referred to herein as a third party mode.

In the third party mode of operation, the data owners do not receive data sketches of other data owners. Instead, the data analytics engine 130 is configured to receive the data sketches of each data owner and perform data sketch operations thereafter (e.g., set operations, theta-operations, etc.) to generate combined data. By one embodiment, upon generating the combined data, the data analytics engine 130 transmits the combined data to at least some of the data owners. It must be appreciated that similar to symmetric and asymmetric mode of operation, in the third party mode of operation, each data owner generates its respective data sketch based on mapping information received from a particular data owner. Furthermore, it must be appreciated that in the third party mode of operation, as each data owner does not receive data sketches of other data owners, risks involved with data sharing are mitigated in an efficient manner.

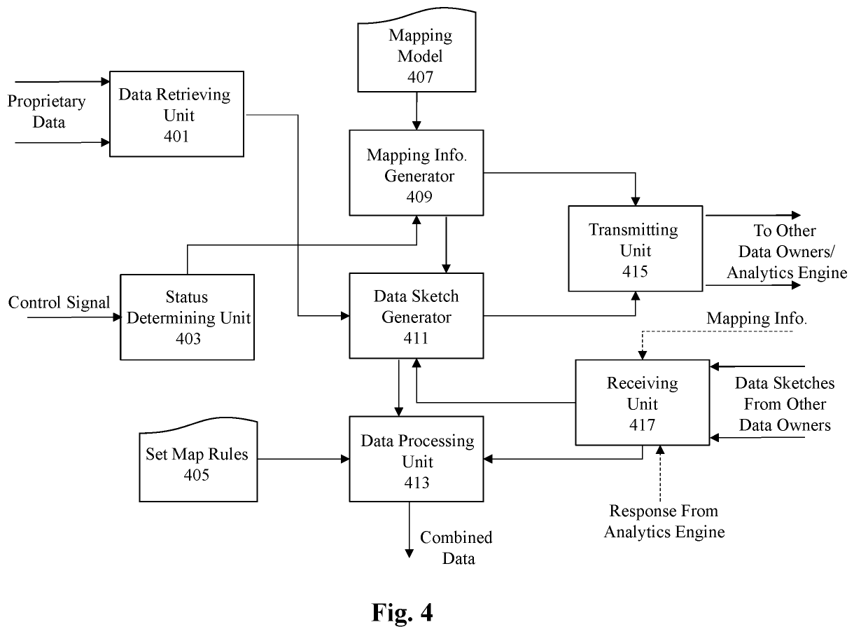

FIG. 4 depicts an exemplary high-level system diagram of a data owner e.g. data owner 110-a, according to an embodiment of the present teaching. The data owner includes a data retrieving unit 401, a status determining unit 403, a mapping information generator 409, a data sketch generator 411, a transmitting unit 415, a receiving unit 417, and a data processing unit 413.

The data retrieving unit 401 retrieves the proprietary data of the data owner and transmits the proprietary data to the data sketch generator 411. By one embodiment, the data sketch generator 411 generates a Theta sketch with respect to the proprietary data. Details regarding the generation of a Theta sketch are described next with reference to FIGS. 6 and 7.

The status determining unit 403 is configured to determine a status of operation of the data owner in the particular data sharing mode in which the data owner is participating. For example, the status determining unit determines based on a control signal (generated by a controller (not shown)) whether the data owner is operating as a master data owner or a participant data owner. In response to determining that the data owner is operating as a master data owner, the status determining unit 403 triggers the mapping information generator 409 to generate mapping information. The mapping information generator 409 generates mapping information in accordance with a mapping model 407. The generated mapping information is forwarded to the data sketch generator 411 and transmitted via the transmitting unit 415 to all other data owners. The mapping information ensures that all the data owners map users in a common ID space.

The data sketch generated by the data sketch generator 411 is transmitted via the transmitting unit 415 to either a third party engine or one or more other data owners based on the mode of data sharing. The receiving unit 417 is configured to receive mapping information from another data owner in case the present data owner is operating as a participant data owner. The received mapping information is forwarded to the data sketch generator 411, such that the data owner generates its data sketch based on the received mapping information. Additionally, the receiving unit receives data sketches from other data owners based on the mode of data sharing.

The data processing unit 413 receives the data sketch generated by the data sketch generator (i.e., data sketch corresponding to the data owners proprietary data) as well as data sketches of other data owners based on the mode of data sharing. The data processing unit 413 is configured to perform data sketch operations (e.g., set operations, theta-operations, etc.) to generate combined data in accordance with set map rules 405. It must be appreciated that in case of operating in the third party mode of data sharing, the receiving unit is also configured to receive the combined data from the analytics engine.

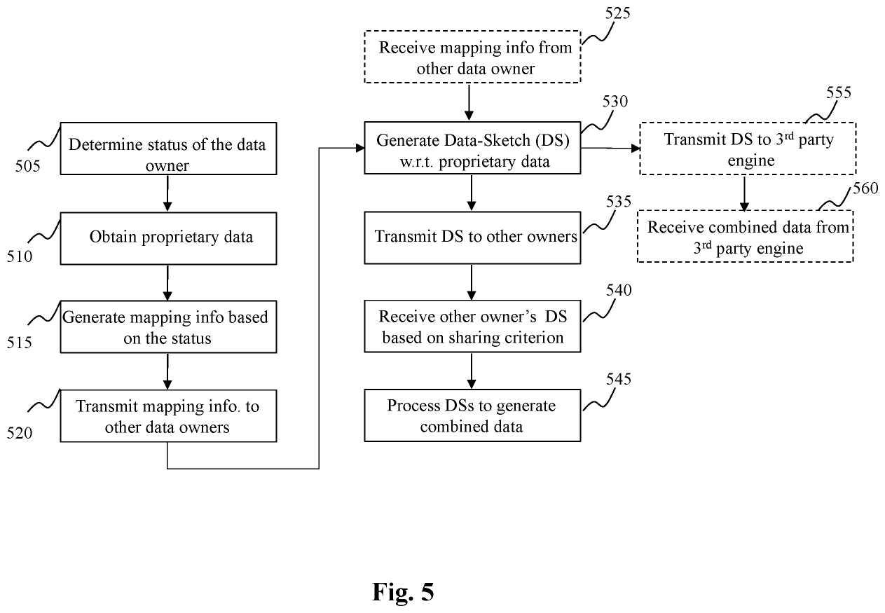

FIG. 5 is a flowchart of an exemplary process performed by a data owner, according to an embodiment of the present teaching. The process commences in step 505 wherein a status of the data owner i.e., master or participant is determined. In step 510, proprietary data belonging to the data owner is obtained.

In step 515, in response to determining that the data owner is a master data owner, mapping information is generated in accordance with a mapping model. In step 520, the generated mapping information is transmitted to all other data owners. However, if the data owner is operating as a participant data owner, in step 525, the data owner receives mapping information from another data owner i.e., the data owner that is operating as a master.

In step 530, the data owner generates a data sketch e.g., a Theta sketch with respect to its proprietary data. Based on the mode of data sharing, the data owner transmits the generated data sketch to one or more other data owners (symmetric or asymmetric mode) in step 535 or transmits the generated data sketch to a third party engine (third party mode of sharing) as shown in step 555.

In step 540, based on the mode of data sharing, the data owner receives data sketches from other data owners and processes the received data sketches (based on set map rules) in step 545 to generate combined data. However, if the mode of operation of data sharing is a third party mode, then in step 560 the data owner receives combined data from the third party engine.

FIG. 6 depicts an exemplary high-level system diagram of a sequential Theta sketch generator (also referred to herein as Θ-sketch generator), according to an embodiment of the present teaching. The Θ-sketch generator includes a hash generator 610, a comparator 620, and a sketch generating unit 640. The sketch generating unit 640 is configured to generate a Θ-sketch 650, which is associated with a threshold value (Θ) 630. The Θ-sketch 650 may be generated to address queries such as “what is the number of unique data elements in a data stream?”.

By one embodiment of the present teaching, the data-structure associated with the Θ-sketch 650 is a fixed sized array (i.e., an array of K elements). A Θ-sketch including K elements (or samples) provides, within a bounded error, an unbiased approximation of the number of unique data elements that are included in an input data stream, as described below.

The hash generator 610 computes a hash value for each element of an input data stream in accordance with a hashing model 615. The hashing model 615 may be a hash function whose outputs are uniformly distributed in a predetermined range (e.g., in a range from 0 to 1). Moreover, the value of the threshold Θ 630 associated with the Θ-sketch is also maintained within the same predetermined range.

The comparator 620 compares the hash value of the input data element to the threshold Θ, 630. In case the hash value is smaller than the threshold Θ, 630, then the hash value is transmitted to the sketch generating unit 640 to be included in the Θ-sketch 650. If the hash value of the data element is greater than the threshold Θ, 630, then the corresponding data element (and its hash value) is ignored. It must be appreciated that since the hash outputs are uniformly distributed in the predetermined range, an expected portion (Θ) of the hash values are smaller than the threshold Θ and are thus included in the Θ-sketch. Accordingly, one can estimate the number of unique data elements in the input data stream by simply dividing the number of (unique) stored samples in the Θ-sketch by the value of the threshold Θ. Moreover, the error in the approximation of the number of unique elements in the data stream depends on the size of the Θ-sketch i.e., the size K of the fixed array.

The Θ-sketch 650 is a fixed sized array maintained independently of the size of the input data stream. Moreover, the sketch generating unit 640 adjusts the threshold Θ 630 on the fly, and prunes elements of the data stream whose hashes are greater than the threshold Θ 630. Specifically, when the predetermined range of the hashing function 615 is between 0-1, the threshold Θ, 630 is assigned a value of 1 for the first K updates. Thereafter, the sketch generating unit 640 adjusts the value of the threshold Θ 630 to be the largest element in the array. Specifically, once the fixed sized array is full, every update that inserts a new element into the array, also removes the largest element in the array. The threshold Θ is updated by assigning the largest element as the new threshold Θ. It must be appreciated that since the size of the fixed array is considerably smaller than the number of elements (N) in the data stream (i.e., K<<N), the vast majority of hashes are larger than Θ, and thus most update operations complete without updating the fixed sized array.

FIG. 7 is a flowchart of an exemplary process of a sequential Θ-sketch generator, according to an embodiment of the present teaching. The process commences in step 710, wherein the Θ-sketch generator receives a data element from an input data stream. In step 720, a hash value for the data element is computed in accordance with a hashing model.

In step 730, a query is performed to determine whether the computed hash value of the data element is smaller than a threshold (Θ) associated with the Θ-sketch. If the response to the query is negative, the process loops back to step 710 to process the next element of the data stream. However, if the response to the query if affirmative, the process moves to step 740.

In step 740, the hash value associated with the data element is added to the Θ-sketch. The process then proceeds to step 750, wherein a further query is performed to determine whether a size of the Θ-sketch (i.e., number of samples included in the Θ-sketch) is greater than the predetermined size of K elements. If the response to the query is negative, the process loops back to step 710.

However, if the response to the query in step 750 is affirmative, the process proceeds to step 760, wherein the size of the Θ-sketch is maintained at the pre-determined value (K), and largest sample in the Θ-sketch (i.e., the largest hash value computed thus far) is assigned to the threshold (Θ). In other words, as stated previously, once the size of the Θ-sketch reaches the predetermined value of K, each update that inserts a new sample (i.e., new hash value) into the sketch, correspondingly also removes the largest sample in the sketch. The largest sample is assigned as the new threshold value Θ. Thereafter, the process loops back to step 710 to process the next data element of the input data stream.

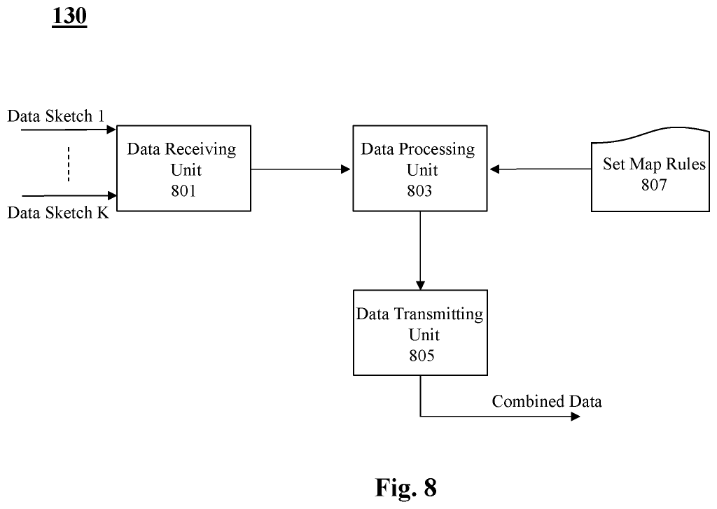

FIG. 8 depicts an exemplary high-level system diagram of a data analytics engine 130, according to an embodiment of the present teaching. The data analytics engine 130 includes a data receiving unit 801, a data processing unit 803, and a data transmitting unit 805.

The data receiving unit 801 receives data sketches that are generated by the respective data owners. Upon receiving the data sketches, the data processing unit 803 combines the data sketches to generate combined data. By one embodiment, the data processing unit 803 performs data sketch operations (e.g., set operations, theta-operations, etc.) to generate combined data based on the set map rules 807. The data transmitting unit 805 may be configured to transmit the combined data to at least some of the data owners based on certain criteria e.g., business agreements between the data owners etc.

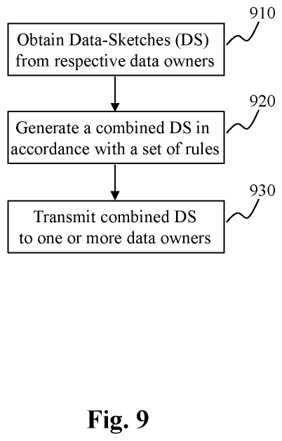

FIG. 9 is a flowchart of an exemplary process performed by a data analytics engine, according to an embodiment of the present teaching. The process commences in step 910, wherein the data analytics engine receives data sketches from respective data owners. In step 920, the data analytics engine generates a combined data sketch in accordance with a set of rules. Upon generating the combined data sketch, in step 930, the data analytics engine transmits the combined data sketch to one or more data owners.

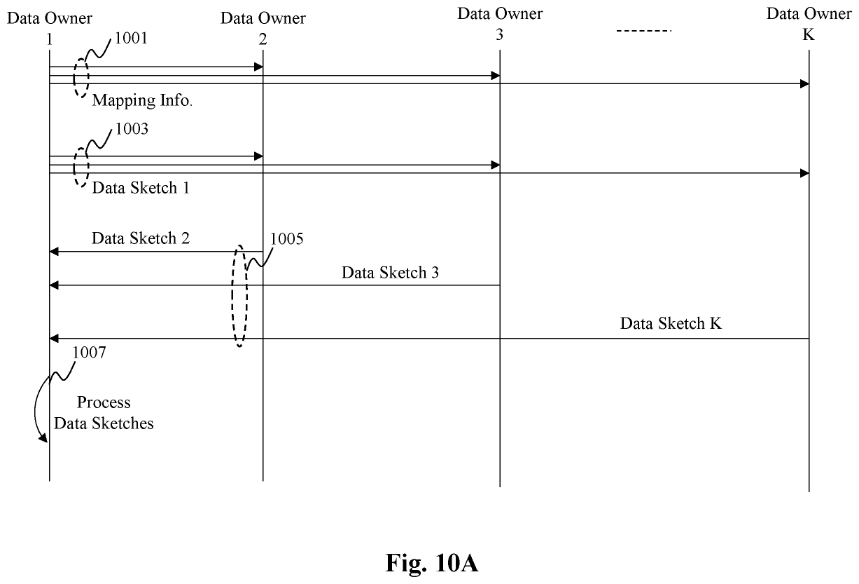

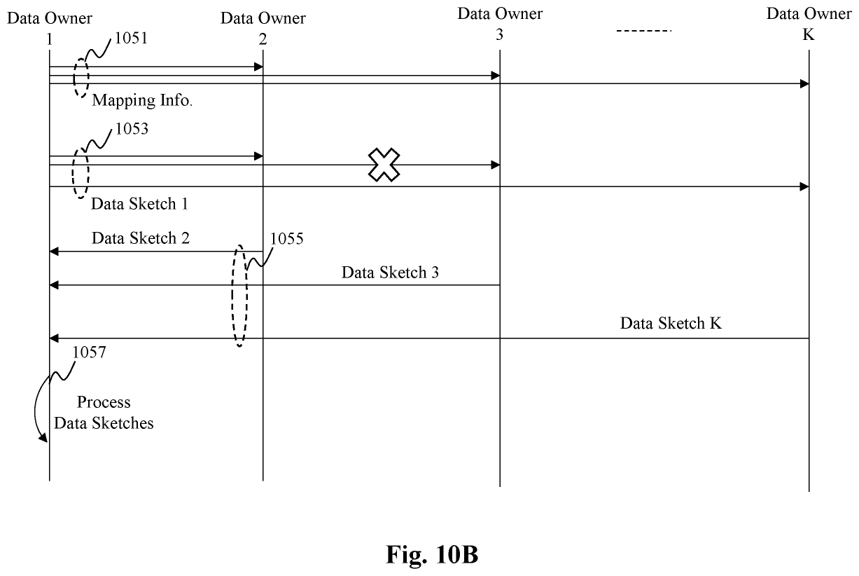

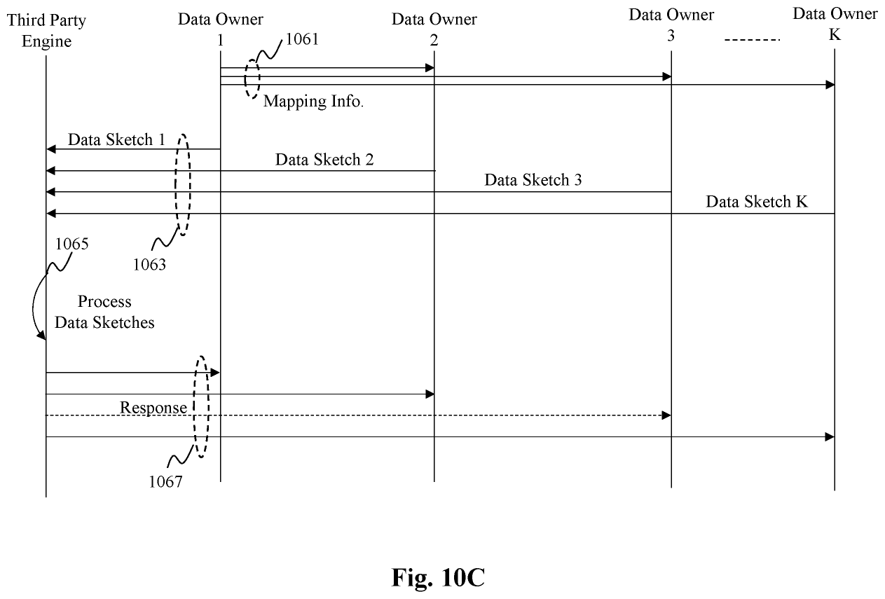

Turning now to FIG. 10A, there is depicted an exemplary timing diagram of a symmetric mode of data sharing, according to an embodiment of the present teaching. In the symmetric mode of operation, a particular data owner (e.g., data owner 1) generates mapping information and transmits the generated mapping information to all other data owners (step 1001). It must be appreciated that the selection of the particular data owner that is configured to generate and transmit the mapping information may be based on several criterion such as selecting the data owner with the most amount of proprietary data, business agreements between the various data owners, etc.

Upon generating and transmitting the mapping information, in step 1003, the data owner 1001 generates a data sketch (e.g., Theta sketch) based on its proprietary data and transmits the generated data sketch to all other data owners. Each of the other data owners i.e., data owner 2, data owner 3, . . . data owner K, generates a data sketch corresponding to its proprietary data based on the mapping information received from data owner 1. Further, as shown in step 1005, each of the other data owners transmits their respectively generated data sketch to all other data owners. Note that for sake of clarity, in FIG. 10A, the data sketches generated by data owners 2, 3, . . . K are shown to be transmitted to only data owner 1.

In this manner, each data owner has a copy of data sketches of all other data owners. Further, in step 1007, each data owner may perform data sketch operations (e.g., set operations, theta-operations, etc.) to generate combined data. Once again, for the sake of clarity, only data owner 1 is shown as processing the data sketches to generate the combined data.

FIG. 10B depicts an exemplary timing diagram of an asymmetric mode of data sharing, according to an embodiment of the present teaching. In the asymmetric mode of operation, a particular data owner (e.g., data owner 1) generates mapping information and transmits the generated mapping information to all other data owners (step 1051). Similar to the case of symmetric mode of operation, in the asymmetric mode of operation, the selection of the particular data owner that is configured to generate and transmit the mapping information may be based on several criterion such as selecting the data owner with the most amount of proprietary data, business agreements between the various data owners, etc.

Upon generating and transmitting the mapping information, in step 1053, the data owner 1051 generates a data sketch (e.g., a Theta sketch) based on its proprietary data and transmits the generated data sketch (data sketch 1) to one or more other data owners. For instance, as shown in FIG. 10B, data owner 1 transmits data sketch 1 to data owners 2 and K but does not transmit the sketch to data owner 3. The determination as to which data owners should data owner 1 transmit its data sketch to may be based on predetermined business agreements between the data owners.

Further, each of the other data owners i.e., data owner 2, data owner 3, . . . and data owner K generates a data sketch corresponding to its proprietary data (i.e., data sketch 2, data sketch 3, . . . data sketch K, respectively) based on the mapping information received from data owner 1. In step 1055, each of the other data owners transmits its generated data sketch to one or more other data owners. In the example depicted in Fig.10B, the data owners 2, 3, . . . K are depicted as transmitting their respective data sketches to data owner 1. In this manner, in the asymmetric mode of operation, each data owner has access to one or more data sketches. Further, in step 1057, each data owner may perform data sketch operations (e.g., set operations, theta-operations, etc.) to generate combined data. Once again, for the sake of clarity, only data owner 1 is shown as processing the data sketches to generate combined data. However, it must ye appreciated that other data owners can perform similar sketch operations on the data sketches received by the data owner.

FIG. 10 C depicts an exemplary timing diagram of a third party mode of data sharing, according to an embodiment of the present teaching. In this mode of operation, a particular data owner (e.g., data owner 1) generates mapping information and transmits the generated mapping information to all other data owners (step 1001). Similar to the symmetric and asymmetric mode of operation, in the third party mode of operation, the selection of the particular data owner that is configured to generate and transmit the mapping information may be based on several criterion such as selecting the data owner with the most amount of proprietary data, business agreements between the various data owners, etc.

Further, each data owner i.e., data owner 1, data owner 2, . . . , and data owner K generates a data sketch (corresponding to its proprietary data) based on the mapping information. As shown in FIG. 10C, in step 1063, each of the data owner transmits its generated data sketch to a third party engine (e.g., the analytic engine of FIG. 3). Thus, in the third party mode of operation, none of the individual data owners have access to data sketches of other data owners.

In step 1065, the third party engine performs data sketch operations (e.g., set operations, theta-operations, etc.) with respect to the received data sketches to generate combined data. In step 1067, the third party engine transmits the combined data to one or more data owners based on a criterion e.g., predetermined business agreements.

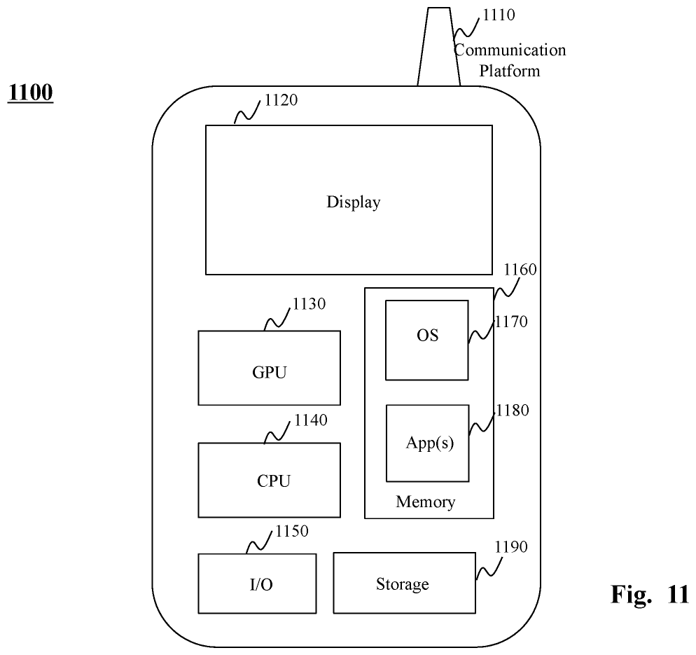

Turning now to FIG. 11, there is depicted an architecture of a mobile device 1100, which can be used to realize a specialized system implementing the present teaching. In this example, a user device on which the functionalities of the various embodiments described herein can be implemented is a mobile device 1100, including, but not limited to, a smart phone, a tablet, a music player, a handled gaming console, a global positioning system (GPS) receiver, and a wearable computing device (e.g., eyeglasses, wrist watch, etc.), or in any other form factor.

The mobile device 1100 in this example includes one or more central processing units (CPUs) 1140, one or more graphic processing units (GPUs) 1130, a display 1120, a memory 1160, a communication platform 1110, such as a wireless communication module, storage 1190, and one or more input/output (I/O) devices 1150. Any other suitable component, including but not limited to a system bus or a controller (not shown), may also be included in the mobile device 1100. As shown in FIG. 11, a mobile operating system 1170, e.g., i0S, Android, Windows Phone, etc., and one or more applications 1180 may be loaded into the memory 1160 from the storage 1190 in order to be executed by the CPU 1140. The applications 1180 may include a browser or any other suitable mobile apps for performing the various functionalities on the mobile device 1100. User interactions with the content displayed on the display panel 1120 may be achieved via the I/O devices 1150.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

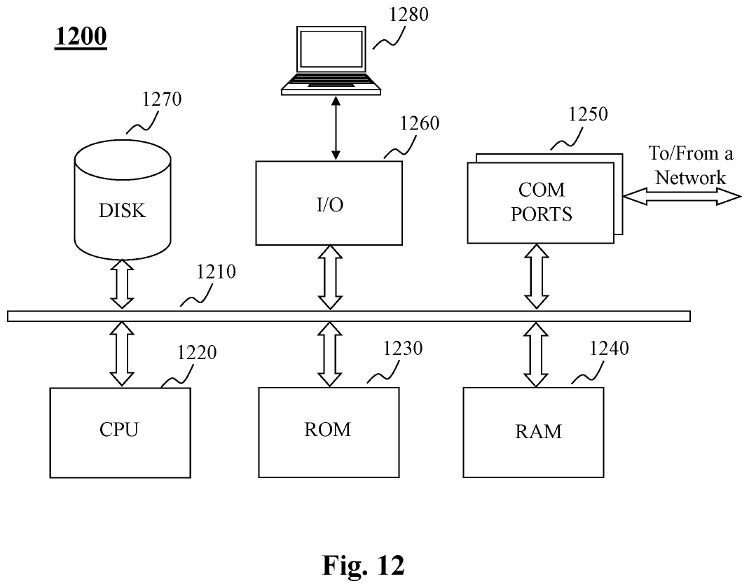

FIG. 12 is an illustrative diagram of an exemplary computer system architecture, in accordance with various embodiments of the present teaching. Such a specialized system incorporating the present teaching has a functional block diagram illustration of a hardware platform which includes user interface elements. Computer 1200 may be a general-purpose computer or a special purpose computer. Both can be used to implement a specialized system for the present teaching. Computer 1200 may be used to implement any component(s) described herein. For example, the present teaching may be implemented on a computer such as computer 1200 via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 1200, for example, may include communication ports 1250 connected to and from a network connected thereto to facilitate data communications. Computer 1200 also includes a central processing unit (CPU) 1220, in the form of one or more processors, for executing program instructions. The exemplary computer platform may also include an internal communication bus 1210, program storage and data storage of different forms (e.g., disk 1270, read only memory (ROM) 1230, or random access memory (RAM) 1240), for various data files to be processed and/or communicated by computer 1200, as well as possibly program instructions to be executed by CPU 1220. Computer 1200 may also include an I/O component 1260 supporting input/output flows between the computer and other components therein such as user interface elements 1280. Computer 1200 may also receive programming and data via network communications.

Hence, aspects of the present teaching(s) as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of the proprietary data owner into the hardware platform(s) of a computing environment or other system implementing a computing environment or similar functionalities in connection with data processing. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the mechanisms of data sharing and combining, as disclosed herein, may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform capable of connecting to a network for securely sharing data between a group of data owners, the method comprising:
generating by a data owner, mapping information in accordance with a model;
generating by the data owner, a first data-sketch corresponding to proprietary data associated with the data owner;
transmitting the mapping information and the first data-sketch to other data owners in the group of data owners;
receiving, from each of the other data owners, a second data-sketch corresponding to proprietary data associated with the other data owner, wherein the second data-sketch is generated based on the mapping information; and
processing the first data-sketch and second data-sketches to generate combined data.

2. The method of claim 1, wherein each of the first data-sketch and the second data-sketch is a Theta sketch.

3. The method of claim 2, wherein the step of generating the first data-sketch further comprises:
computing a hash value for each data element included in the proprietary data associated with the data owner; and
inserting the hash value in the theta sketch based on the hash value being lower than a threshold value associated with the theta sketch.

4. The method of claim 1, wherein the step of processing further comprises:
combining the first data-sketch and second data-sketches in accordance with data-sketch set operations to generate the combined data.

5. The method of claim 1, wherein the data owner generates the mapping information in response to determining that the data owner is selected to operate as a master data owner within the group of data owners.

6. The method of claim 1, wherein each of the other data owners transmits the second data-sketch to all other data owners in the group of data owners.

7. A non-transitory computer readable medium including computer executable instructions, wherein the instructions, when executed by a computer, cause the computer to perform a method for securely sharing data between a group of data owners, the method comprising:
generating by a data owner, mapping information in accordance with a model;
generating by the data owner, a first data-sketch corresponding to proprietary data associated with the data owner;
transmitting the mapping information and the first data-sketch to other data owners in the group of data owners;
receiving, from each of the other data owners, a second data-sketch corresponding to proprietary data associated with the other data owner, wherein the second data-sketch is generated based on the mapping information; and
processing the first data-sketch and second data-sketches to generate combined data.

8. The medium of claim 7, wherein each of the first data-sketch and the second data-sketch is a Theta sketch.

9. The medium of claim 8, wherein the step of generating the first data-sketch further comprises:
computing a hash value for each data element included in the proprietary data associated with the data owner; and
inserting the hash value in the theta sketch based on the hash value being lower than a threshold value associated with the theta sketch.

10. The medium of claim 7, wherein the step of processing further comprises:
combining the first data-sketch and second data-sketches in accordance with data-sketch set operations to generate the combined data.

11. The medium of claim 7, wherein the data owner generates the mapping information in response to determining that the data owner is selected to operate as a master data owner within the group of data owners.

12. The medium of claim 7, wherein each of the other data owners transmits the second data-sketch to all other data owners in the group of data owners.

13. A system for securely sharing data between a group of data owners, the system comprising:
a mapping information generator configured for generating mapping information associated with a data owner in accordance with a model;
a data-sketch generator configured for generating, a first data-sketch corresponding to proprietary data associated with the data owner;
a transmitting unit configured for transmitting, the mapping information and the first data-sketch to other data owners in the group of data owners;
a receiving unit configured for receiving, from each of the other data owners, a second data-sketch corresponding to proprietary data associated with the other data owner, wherein the second data-sketch is generated based on the mapping information; and
a data processing unit configured for processing, the first data-sketch and second data-sketches to generate combined data.

14. The system of claim 13, wherein each of the first data-sketch and the second data-sketch is a Theta sketch.

15. The system of claim 14, wherein the data-sketch generator is further configured for:
computing a hash value for each data element included in the proprietary data associated with the data owner; and
inserting the hash value in the theta sketch based on the hash value being lower than a threshold value associated with the theta sketch.

16. The system of claim 13, wherein the data processing unit is further configured for:
combining the first data-sketch and second data-sketches in accordance with data-sketch set operations to generate the combined data.

17. The system of claim 13, wherein the data owner generates the mapping information in response to determining that the data owner is selected to operate as a master data owner within the group of data owners.

18. The system of claim 13, wherein each of the other data owners transmits the second data-sketch to all other data owners in the group of data owners.
